(19) United States
(12) Patent Application Publication
(10) Pub. No.: US 2020/0210978 A1
(43) Pub. Date: Jul. 2, 2020

(54) Blockchain-Based Value Platform

(71) Applicant: Suzanne Brown, Zurich (CH)

(72) Inventor: Suzanne Brown, Zurich (CH)

(21) Appl. No.: 16/730,183

(22) Filed: Dec. 30, 2019

Related U.S. Application Data
(60) Provisional application No. 62/787,078, filed on Dec. 31, 2018.

(51) Int. Cl. G06Q 20/12; H04L 9/06; H04L 9/32; G06F 3/01

(52) U.S. Cl. CPC G06Q 20/1235; G06F 3/011; H04L 9/3213; H04L 9/0637

(57) ABSTRACT

A method of executing a blockchain platform includes providing, to be displayed on a client device, a virtual representation of a user, wherein the virtual representation comprises a plurality of graphical elements corresponding to a plurality of relationships of the user. The method further includes detecting, by a processing device of the blockchain platform, that a triggering event was performed. The method further includes, in response to detecting that the triggering event was performed, generating a blockchain token corresponding to the user. The method further includes receiving a request from the client device to redeem the blockchain token. The method further includes, in response to receiving the request, generating a new graphical element, representing the blockchain token, for the virtual representation of the user. The method further includes providing, to be displayed on the client device, an updated virtual representation including the new graphical element.

### REFERENCE TO RELATED APPLICATION

This application claims the benefit of U.S. Provisional Application No. 62/787,078, filed Dec. 31, 2018, which is hereby incorporated by reference in its entirety.

### FIELD OF TECHNOLOGY

The embodiments described herein pertain in general to a blockchain-based platforms and, more particularly, to blockchain-based value platforms.

### BACKGROUND

Blockchain systems provide a reliable, distributed, immutable, and persistent record of transactions corresponding to some digital asset. Blockchain systems use decentralization and cryptographic hashing techniques to generate and verify new transaction to a distributed ledger.

Currently popular blockchain applications include digital currency systems such as Bitcoin and Ethereum. Such digital currently platforms generate and verify tokens having a monetary value based on demand.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating a blockchain system, in accordance with some embodiments.

FIG. 2 is a block diagram illustrating blockchain transaction blocks, in accordance with some embodiments.

FIG. 3 is a block diagram illustrating an example token exchange, in accordance with some embodiments.

FIG. 4 is a block diagram illustrating an example token merge, in accordance with some embodiments.

FIG. 5 is a block diagram illustrating an example token split and exchange, in accordance with some embodiments.

FIG. 6 is a block diagram illustrating an example token generation, in accordance with some embodiments.

FIG. 7 is a block diagram illustrating an example graphical user interface, including various graphical elements, in accordance with some embodiments.

FIG. 8 is a block diagram illustrating example graphical user interface, including various connections represented by graphical elements, in accordance with some embodiments.

FIG. 9 is a block diagram illustrating an example physical paper token, in accordance with some embodiments.

FIG. 10 is a block diagram illustrating a cloud-based token exchange, in accordance with some embodiments.

FIG. 11 is a block diagram illustrating an example token mining, in accordance with some embodiments.

FIG. 12 is a block diagram illustrating a first example validation operation, in accordance with some embodiments.

FIG. 13 is a block diagram illustrating a second example validation operation, in accordance with some embodiments.

FIG. 14A is a flow diagram of a method for blockchain-based value platform operations, in accordance with some embodiments of the present disclosure.

FIG. 14B is an illustration showing an example computing device which may implement the embodiments described herein.

### DETAILED DESCRIPTION

Blockchain technology may provide a reliable, distributed, public, immutable ledger of transactions, and it is being used as the basis for a variety of distributed applications. However, the many advantages of blockchain systems come at a cost. For example, due to the distributed nature of the technology, each gigabyte of data that is added to a blockchain must be transmitted over the Internet to distributed computing systems computing devices, client devices, computers, etc.), often called peers, that maintain the blockchain. This same gigabyte must be verified, run through hash functions, and stored perpetually. In short, adding data to a blockchain may be expensive.

As a result, application developers have greatly restricted the data that is stored on blockchains and by extension, the type of applications for which blockchain is used. For example, popular blockchain applications include cryptocurrency systems, such as Bitcoin and Ethereum. These systems may store little more than the alias of the buyer, the alias of the seller, and the amount of the corresponding transaction. Bitcoin, for example, allows only an additional 83 bytes of information per transaction. Furthermore, such systems use artificial scarcity in the form of cryptographic hashes to create demand, and therefore value. These systems do not encourage collaboration towards a common goal, nor do they promote self-improvement.

It would be advantageous in a variety of contexts to build a blockchain application that is not based on artificial scarcity and instead, promotes the improvement of one's self through alignment with true self and sharing this value with others. In one example, such a system may be used to generate and maintain a reliable, distributed, immutable ledger of tokens and transactions that spur positive change and edification.

In one embodiment, to overcome some of the problems described above, systems and methods are described herein for a blockchain-based virtual value platform. Such a platform is capable of measuring and tracking a user's value to him or herself, and to the community as a whole. In one embodiment, this is achieved by rewarding of individuals for doing good or achieving a higher state of being (e.g., a “flow state) with generated tokens, with which users may perform a variety of actions and redeem for a variety of digital and/or physical objects.

In one embodiment, the platform described herein may be displayed and/or played in the form of a game (e.g., mobile game, computer game, etc.). For example, users may be encouraged to perform real actions that better themselves or those around them, and in exchange may be rewarded with virtual or physical tokens for their efforts. Such tokens may be redeemed for virtual elements in the game or even monetary value in the form of fiat currency.

In one exemplary embodiment, a method of interacting with such a platform may include providing, to be displayed on a client device, a virtual representation of a user, wherein the virtual representation comprises a plurality of graphical elements corresponding to a plurality of relationships of the user. The method may further include detecting, by a processing device of the blockchain platform, that a triggering event was performed. The method may further include, in response to detecting that the triggering event was performed, generating a blockchain token corresponding to the user. The method may further include, receiving a request from the client device to redeem the blockchain token and, in response to receiving the request, generating a new graphical element, representing the blockchain token, of the virtual representation of the user. The method may further include providing, to be displayed on the client device, an updated virtual representation including the new graphical element.

The present embodiments are generally directed to an entirely new asset class (e.g., intrinsic value—your inner value as an individual or organization) and how it is measured, rewarded and tokenized for storing, sharing, and exchanging. Examples include any means by which intrinsic value is measured and rewarded in a person or an organization. The current financial systems do not value or measure intrinsic value, nor does it contemplate the economics of intrinsic value. Notably, few individuals understand that intrinsic value is worth more than extrinsic monetary value. Even harder to understand is that something with high intrinsic value does not necessarily follow the economics of scarcity, lack, or supply and demand. In today's extrinsically measured and valued metrics, something is worth more if it is scarce and therefore the supply needs to be limited.

Achieving states of flow, resonance, coherency, or alignment, as described herein, carry high intrinsic value because they result in optimal mental, physical, emotional etc. performance (e.g., clarity, win-win solutions, peak performance, spontaneous healing, etc.), and feelings of happiness, peacefulness, fulfillment, self-realization, self-actualization, appreciation, love, compassion, etc. None of these are worth less the more you have. Intrinsic value is unlimited and the more you have, the more it is worth. Notably, this concept is counter-intuitive from traditional extrinsic economics.

For this reason, the tokens described herein may not have an upper limit on the number that can be issued. All other digital tokens have an upper limit because they are focused on values that are limited. Intrinsic value is unlimited. Human potential is unlimited.

The body of embodiments described herein shall present the technical means and implementation by which a person's personal intrinsic value, which is currently intangible, can be represented, enhanced, measured, and transmitted virtually or physically between real people and/or intangible entities (e.g., legal companies). These embodiments may be used together or independently. They encompass various themes of embodiments, including what shall be referred to as the “Tree of Life,” “Alloy Tokens,” “Real Tokens,” and “Resonance Tokens/Devices.”

It should be noted that although some of the embodiments and examples provided herein are described with respect to a variety of types of transactions for convenience, the methods and systems described herein are not limited to any particular type of transaction or data.

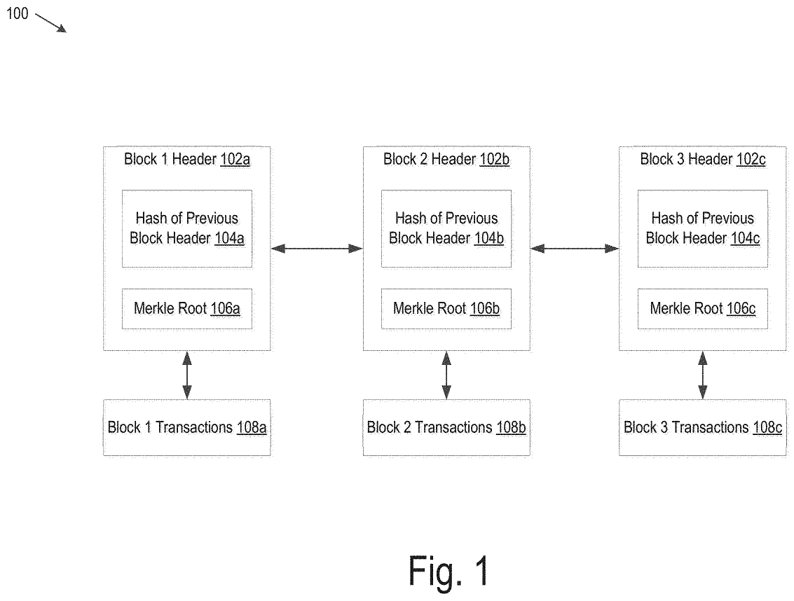

FIG. 1 is a block diagram illustrating blockchain system 100, in accordance with some embodiments. Although specific components are disclosed in blockchain system 100, it should be appreciated that such components are examples. That is, embodiments of the present invention are well suited to having various other components or variations of the components recited in blockchain system 100. It is appreciated that the components in blockchain system 100 may operate with components other than those presented, and that not all of the components of blockchain system 100 may be required to achieve the goals of blockchain system 100.

Blockchain system 100 may be a decentralized, peer-to-peer networking system. Without a central authority, operations (e.g., transactions) of blockchain system 100 may be managed collectively by peers in the system. Transactions may occur between peers directly and may be recorded on the blockchain itself.

In FIG. 1, blockchain system 100 is a decentralized public database that includes a variety of components, including blockchain headers (102a-c) and block transactions (108a-c), and subcomponents, including hashes of previous block headers (104a-c), Merkle Roots (106a-c), and transactions (110a-c). In one embodiment, each block contains a record of recent transactions (e.g., transactions 110a) and a header (e.g., 102a) including a reference to the block that came before it (e.g., 104a) and the solution to a complex mathematical puzzle (e.g., 106a) among other data (e.g., a timestamp).

In one embodiment, a blockchain is collectively maintained by “miners,” who are members within the network that compete to validate blockchain transactions in each block by solving the complex mathematical problem associated with the block. In one embodiment, miners are incentivized to validate blockchain transactions by rewarding them with some amount of monetary compensation upon successful completion.

In one embodiment, as described herein, data contained in a block header and/or block transaction data may include data relating to an intrinsic-value of an individual or organization, triggering event that led to a creation of one or more tokens, and any other suitable information. In one embodiment, a blockchain token described herein is a cryptographic token that refers to assets and/or access rights that are collectively managed by a network of computers, a blockchain network, or other distributed ledger. A distributed ledger provides a universal state layer, a public infrastructure in the form of a distributed record of transactions that keeps track of which wallet address is the owner of which token.

In one embodiment, blockchain tokens represent a set of rules, encoded in a smart contract. Every token may be associated with a blockchain address. These tokens may be accessible with software that communicates with the blockchain and manages the public-private key pair related to the blockchain address. Only the person who has the private key for that address can access the respective tokens. This person can, therefore, be regarded as the owner or custodian of that token. If the token represents an asset, the owner can initiate transfer of the tokens by signing with their private key, which in turn generates a digital fingerprint or digital signature. If the token represents an access right to something somebody else owns, the owner of that token can initiate access by signing with their private key, thereby creating a digital fingerprint.

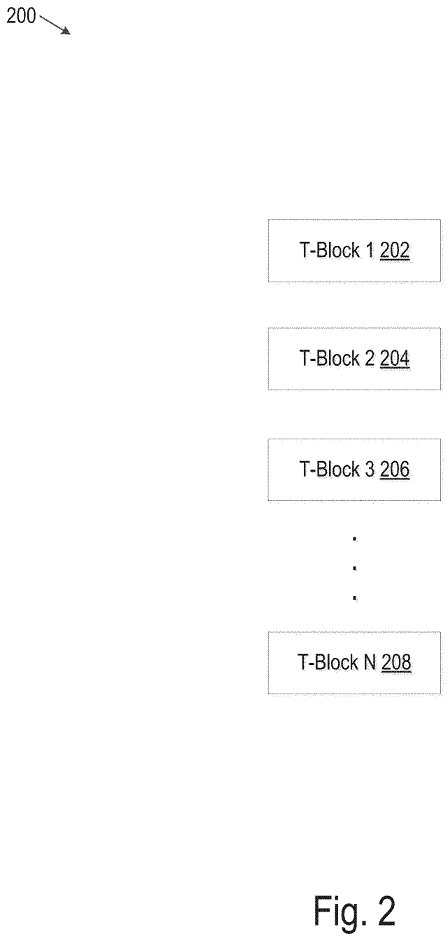

FIG. 2 is a block diagram illustrating blockchain 200 transaction blocks 202-208, in accordance with some embodiments. In one embodiment, each of the transaction blocks (e.g., T-blocks) 202-208 may contain uncompressed transaction data. As illustrated the blockchain 202 is a sequence of T-blocks 202-208. Each T-block (e.g., 202-208) in the blockchain 202, may consist of a list of transactions. Each transaction may then contain a list of data fields that describe that particular transaction.

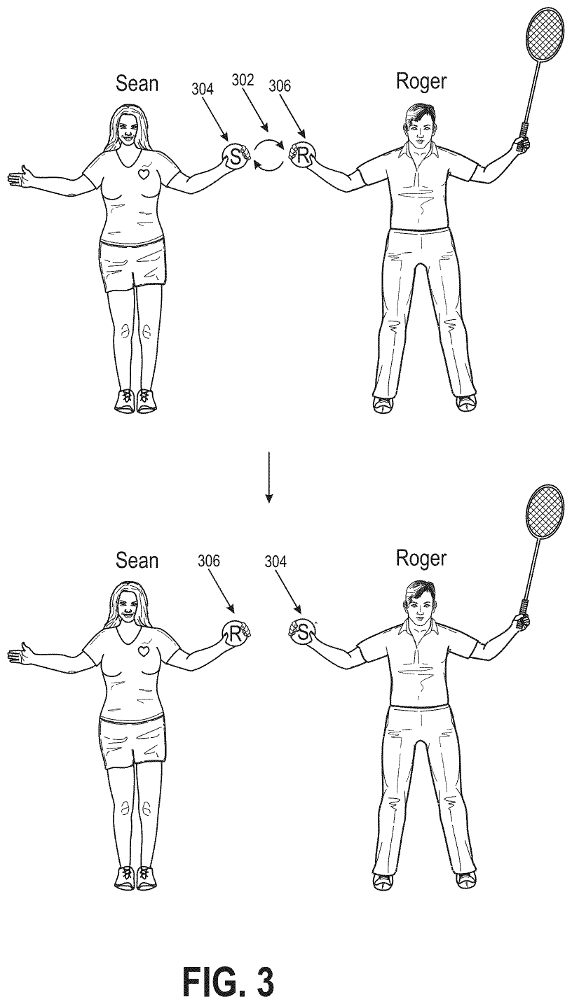

The following FIGS. 3-14 illustrate and describe blockchain-based value platform architecture and operations that may be used in conjunction with the a blockchain system comparable to that described with respect to FIGS. 1-2. In various embodiments, a “tree of life” example of a token platform to represent value (e.g., intrinsic value) is used herein merely for brevity and example. In other embodiments, any other suitable representation may be used in accordance with the platform described herein.

In one embodiment, the tree of life example shall serve as the core, foundation, or root of a “Tree” from which all other embodiments stem. A virtual tree of life may branch out from (e.g., be an extension of) a home tree, which may serve as the virtual representation of intrinsic value. Worth noting, each of the visual representations described herein may be provided for display on a graphical user interface of a software application, web application, mobile application, social media platform, etc. Branches or offspring may represent connections between users and may comprise a family tree. Methods will be offered to increase or enhance one's personal intrinsic value or worthiness and share it with others, including people or legal entities (e.g., organizations).

Additional embodiments described herein demonstrate how to increase the collective intrinsic value of humanity and realize higher levels of human potential and wellbeing, both personally and collectively, through the use of seeds (e.g., tokens). The seeds may be earned through value creation and planted in a user's own garden, or in others', including a common garden. Together, these embodiments may be represented virtually as a home tree with its roots, branches, leaves, flowers and fruit growing on the branches with powerful seeds (filled with intent) to inspire and show each person how to more deliberately create their own reality and the world in which they each want to see and be.

The seasons of the year (fall, spring, etc.) and weather patterns, including rain, snow, dew drops and the animal kingdom (including birds, bees, etc.) as well as mother nature with all of her different trees, plants, flora and fauna may be incorporated in these embodiments to demonstrate to a user how to tend to his or her wellbeing and increase their respective intrinsic value. One example platform for these embodiments may be deployed in the form of a game. Another may be a social impact platform. Yet another may be a financial ecosystem platform whereby the concept of money is naturalized to reflect the mutually beneficial relationships in mother nature and animal nature, such as bees pollinating flowers in the collecting of nectar.

In various embodiments, virtual reality, augmented reality, and mixed reality may be used to enhance all of the features described herein. In whatever way these embodiments are deployed, the family, friends, acquaintances, etc. of users of these embodiments may come to realize that they have greater leverage in amplifying their intrinsic value, intentions, self-worth, and value to others when in resonance or alignment with their true nature or soul, and therefore the source of their life and flow of energy.

In one embodiment, alloy tokens may be used in conjunction with the platform described herein. Such embodiments may include the mixing of values or assets in a virtual or physical token. For example, there may be tokens or cryptocurrencies that represent the value of one asset, e.g., gold, silver, diamonds, real property, bonds, security in a company, etc. The embodiments herein encompass the blending of these assets into an “Alloy Token”, e.g., gold and silver, diamonds and precious metals, real property and non-real property, intellectual property and physical property, security of multiple companies combined, and the mixing or combining of any value between people and/or entities (legal companies).

The present embodiments may encompass the mixing of more than one type of underlying asset or value. More specifically, the mixing of intrinsic value between two or more people, or two or more companies and any combination thereof and representing the combination in a virtual or physical token. For example, ROGER and RAFA, SEAN and MICHAEL, SUZANNE and ALEXANDRA, all team members of the World Cup winners (e.g., French Football team), all staff members of a given company Apple Computer), etc.

Various other embodiments may include the construction of real or physical tokens to actually represent their virtual counter-parts. Similar to how paper fiat money or metal coins represents the underlying debt and/or obligation to honor something, these embodiments may embody the making of a real tangible object to represent a virtual or intangible token of value. Most significantly, these real embodiments may exclusively cover the intrinsic value of a person or legal entity, or any alloy combination thereof. Furthermore, a real token could be connected to a specific user to represent the user's ownership of the real token and the value within. This may be done using a biometric method and/or programmable ID chip within the physical token, similar to ID chips in credit cards. Such a token could be stolen but rendered invalid or untradeable if an unauthorized person were to attempt to use a real token not belonging to them. Advantageously, this would make real tokens safer from theft.

In one embodiment, these real tokens may be more useful than existing forms of paper or coin money (cash), which are not tied to any ownership. Real tokens attached to persons or companies through a form of biometric or electronic ownership would also be beneficial in commemorative tokens, such as the alloy tokens described above. Another benefit lies in the serializing or numbering of real tokens to indicate when minted and/or which one a particular real token is out of the whole. In one embodiment, when the real token is created the corresponding virtual token may be destroyed to avoid double spending between the physical and virtual worlds.

In one embodiment, resonance technology may be used in conjunction with the platform described herein. Resonance may be thought of as reinforcement or prolongation of waves (e.g., sound or light waves) by reflection from a surface or by the synchronous vibration of a neighboring object. In one embodiment, when a person is in resonance with love, the energy that creates worlds flows through them. A stream of Resonance embodiments may convey clarity, alignment, or resonance with your true self, inner self, higher self or source of life energy, all of which resonate with the energy of love. Resonance with the emotion of love may be detected through the magnetic field created by the heart and/or brain waves that radiate while feeling and/or thinking in the absence of any resistance.

In one embodiment, sensor technologies such as NV-doped diamond laser crystals or vapor cell magnetometers can be used as sensitive magnetic field sensors at room temperature to measure “resonant” signals from the heart of brain. Spintronics may also be used to detect and measure magnetic fields from the human body. Researchers have found that holes have many of the right properties for spintronics and in particular a relativistic effect called spin-orbit coupling, where the spin of a charge carrier interacts with its orbital motion. A strong coupling enables researchers to control the particle's spin with an electric field or magnetic field. Various devices may be constructed and are contemplated using these principles, such as wearable devices (e.g., necklaces, pendants, ring, eyeglasses, hats, bracelets, watches, etc.) that may resonate at the frequency of love or other emotions when felt and radiated by the heart, or thoughts of appreciation or other emotions when radiated by the brain.

These resonate states, when achieved, may be amplified and reflected back to the person expressing them and electrically communicated to a nearby device such as a mobile phone or computer device, where such states may be further communicated and become useful in the Tree of Life platform(s) described herein. For example, the detection of particular emotions or states of being using such devices and technologies could result in tokens being received or sent in response, as described in the other embodiments herein. In one embodiment, the Resonate devices described herein may sensitive to the wearer and therefore may be thought of as a radiator of thoughts and feelings, and therefore the skill of the person to focus their thoughts and feelings and achieve resonate states of high vibration.

In one embodiment, such Resonate devices may light up and glow when a person is in resonance, which may transparently communicate to the user and/or others when they are in a resonate state. For example, when a user is talking, a resonance state may literally indicate a good idea from a bad idea (from the perspective of their true self), or high intrinsically valuable thoughts and suggestions that are most likely to lead to better feeling results if followed. Such a device may glow a certain color when in alignment or resonance and another color (or not) when not in alignment/resonance to give feedback to the wearer or others if willing to be fully transparent. A person would know what influence they are under when a thought is received and therefore whether or not to follow the thought or impulse, or whether to take action or not.

In one embodiment, polarized lens technology and/or the use of LEDs may be used in eyeglasses to emit more natural light or brighter colors or sharper focused images when you are in resonance or turn more gray, dull, darker or even fuzzier when not in alignment or resonance, giving the wearer instantaneous feedback of their state relative to being in alignment or resonance with their source, inner self, higher self, or soul.

In some embodiments, these Resonance features may transform the intangible feeling of resonance into more tangible awareness and give users more deliberate control over their lives and more satisfaction with the power to live a more fulfilling and satisfied life. Resonance expresses higher intrinsic value, greater benefit, good ideas, and positive influence or loving intentions. These Resonant embodiments could also be used to uplift and inspire or literally share “good vibes” with others. For example, a resonant diamond could be “charged” with a user's own resonant frequency or a combined resonant frequency with a loved one. These resonant diamonds could be worn as pendants on a necklace or a ring or glasses to radiate a resonant frequency of the user's own alignment or resonance in combination with a loved one or group of people.

In one embodiment, a resonantly charged diamond with someone's essence may be cut into smaller pieces and the person physically separated from the charged diamond at long distances, but still resonate and radiate the frequency of the original charge in the diamond located at any distance away from the person who charged it. In another embodiment, a Resonate device may stay connected to the frequency of radiation of a distance person through quantum tunneling. Such affects would depend on the ability and power of the person doing the charging and radiating.

The Resonance embodiments described herein may be used on their own or in concert with the Tree of life embodiments described herein. Advantageously, the Resonance embodiments, regardless of how they are used, may add to the greater good in the world and provide a tangible method for people to achieve higher levels of happiness and greater satisfaction in moving in the direction of their intentions and values.

The embodiments described herein relate to methods and systems for achieving a state of resonance, the creation of physical tokens to represent or replace their virtual counterparts, alloy tokens of combined value(s), and an entirely new asset class represented on a blockchain, Internet or virtual software platform, network, application, or game. This new asset class is the intrinsic value of a person or legal entity (such as a company).

In one embodiment, a virtual digital token representing a person or entity's potential and intrinsic value is created (e.g., by processing logic) and identified as such on a Blockchain or Internet platform. This virtual digital token is recorded and stored in a database (either decentralized or centralized) as belonging to a particular person or particular organization. The present embodiment refers entirely to this specific asset class (Intrinsic Value) on any Blockchain, Internet or virtual world of software. This virtual asset may (but is not required to) be associated or connected to a particular person or organization by the legal identity of the individual or entity in a very clear and unambiguous way, by validating its identity through various biometric and legally accepted documents, and further having the explicit permission of the identified asset to have its intrinsic value be represented in this way. The embodiment may include creating the token representing the potential intrinsic value of a given person or company to be claimed by that person or entity upon proof of valid identity.

In one embodiment, asset classes on the Blockchain may refer to digitizing a real physical asset, such as real property or precious metals or gems. Other asset classes are the value of the shares in a new Blockchain company that issues its own security tokens. Other asset classes are utility or payment tokens for providing services or payment for services. The asset class of the present embodiment is a virtual token to hold the intrinsic value or self-worth of a person or entity. Such a token may embody a person or organization's inner value, irrespective of its “market” or financial value.

The embodiments herein provide the means by which a person may mine their focused thoughts or achievement of alignment or farm their actions and emotions that increase one's intrinsic value and share or sell corresponding tokens on various markets, including financial markets in exchange for street money or trade it for other tokens of value. A person's intrinsic value has tremendous potential and value to others and therefore has market utility value. These embodiments demonstrate how to enhance a person's intrinsic value and amplify their self-worth and value to others and how to store it and readily share it with others in the most beneficial way.

These embodiments provide the optimal means by which intrinsic value of a person or company can be derived and then be launched as a token to be shared with others. These embodiments may demonstrate that you can never sell your soul or lose it. These embodiments may show how intrinsic value can be recycled or composted and distributed when you physically die, or be made perpetual in an eternal application after you physically die to carry out your legacy.

With ubiquitous internet connections in most places of the world and growing, global information transmission has become incredibly cheap and nearly instantaneous. Technology-rooted movements like Blockchain have demonstrated, through the power of the default, consensus mechanisms and respect of the social contracts that are possible to use the internet to make a decentralized value-transfer system, shared across the world and virtually free to use.

The body of these embodiments may be described using a cryptographically secure ecosystem using transaction-based state machines such as those provided on the Ethereum Blockchain, which offers generalized technology on which all transaction-based state machine concepts can be built. Additional embodiments could just as easily be designed and executed to run on their own Blockchain network as the medium or platform on which the rest of the embodiments stemming from these embodiments could run on top of. These embodiments pave the way for architecting an ecosystem platform in which agreements and smart contracts can be autonomously executed between participants. Good judgment and transparency will come naturally from the algorithmic interpretations stemming from these embodiments. As with the design of Ethereum, users of this embodiment will have absolute confidence in the possible outcomes and how possible outcomes might come about.

In this light, Ethereum may be seen as a general implementation of such a crypto-law system. These embodiments will initially rely on the Ethereum crypto-law platform; however, the intention is for these embodiments to ultimately create a new universal law-based ecosystem based on the natural laws of intrinsic value which are discovered by the users participating in the world created by applying these embodiments as intended and those stemming and branching out from them.

One aspect of Blockchain is “smart contracts,” which may be systems that automatically move digital assets according to pre-specified rules. The logical extension of this is decentralized autonomous organizations (DAOs), which are long-term smart contracts that contain assets and encode the bylaws of an entire organization. Ethereum provides a Blockchain with a built-in fully fledged Turing-complete programming language that can be used to create ‘contracts’ that can be used to encode arbitrary state transition functions, allowing users to create any of the systems described above, as well as many others that we have not yet imagined, simply by writing up the logic in a few lines of code.

One intent of Ethereum is to merge together and improve upon the concepts of scripting, altcoins and on-chain meta-protocols, and allow developers to create arbitrary consensus-based applications that have the scalability, standardization, feature-completeness, ease of development and interoperability offered by these different paradigms all at the same time. Ethereum does this by building what is essentially the ultimate abstract foundational layer: a Blockchain with a built-in Turing-complete programming language, allowing anyone to write smart contracts and decentralized applications where they can create their own rules for ownership, transaction formats and state transition functions.

In Ethereum, the state is made up of objects called “accounts”, with each account having a 20-byte address and state transitions being direct transfers of value and information between accounts. An Ethereum account contains four fields:
The nonce, a counter used to make sure each transaction can only be processed once
The account's current ether balance
The account's contract code, if present
The account's storage (empty by default)

In one embodiment “Ether” is the main internal crypto-fuel of Ethereum, and is used to pay transaction fees. In general, there are two types of accounts: externally owned accounts, controlled by private keys, and contract accounts, controlled by their contract code. An externally owned account has no code, and one can send messages from an externally owned account by creating and signing a transaction; in a contract account, every time the contract account receives a message its code activates, allowing it to read and write to internal storage and send other messages or create contracts in turn.

The code in Ethereum contracts is written in a low-level, stack-based bytecode language, referred to as “Ethereum virtual machine code” or “EVM code”. The code consists of a series of bytes, where each byte represents an operation. In general, code execution is an infinite loop that consists of repeatedly carrying out the operation at the current program counter (which begins at zero) and then incrementing the program counter by one, until the end of the code is reached or an error or STOP or RETURN instruction is detected. The operations have access to three types of space in which to store data:
The stack, a last-in-first-out container to which 32-byte values can be pushed and popped
Memory, an infinitely expandable byte array
The contract's long-term storage, a key/value store where keys and values are both 32 bytes. Unlike stack and memory, which reset after computation ends, storage persists for the long term.

The Ethereum Blockchain is in many ways similar to the Bitcoin Blockchain, although it does have some differences. The main difference between Ethereum and Bitcoin with regard to the Blockchain architecture is that, unlike Bitcoin, Ethereum blocks contain a copy of both the transaction list and the most recent slate. Aside from that, two other values, the block number and the difficulty, are also stored in the block. The block validation algorithm in Ethereum is as follows:
Check if the previous block referenced exists and is valid.
Check that the timestamp of the block is greater than that of the referenced previous block and less than 15 minutes into the future.
Check that the block number, difficulty, transaction root, uncle root and gas limit (various low-level [symbol] Ethereum-specific concepts) are valid.
Check that the proof of work on the block is valid.
Let S[0] be the STATE_ROOT of the previous block.
Let TX be the block's transaction list, with n transactions. For all in in 0 . . . n−1, setS[i+1]=APPLY(S[i],TX[i]). If any applications returns an error, or if the total gas consumed in the block up [symbol] until this point exceeds the GASLIMIT, return an error.
Let S_FINAL be S[n] but adding the block reward paid to the miner.
Check if S_FINAL is the same as the STATE_ROOT. If it is, the block is valid; otherwise, it is not valid,

The state may be stored in the tree structure, and after every block only a small part of the tree needs to be changed. Thus, in general, between two adjacent blocks the vast majority of the tree should be the same, and therefore the data can be stored once and referenced twice using pointers (i.e. hashes of sub-trees). A special kind of tree known as a “Patricia tree” is used to accomplish this, including a modification to the Merkle tree concept that allows for nodes to be inserted and deleted, and not just changed, efficiently. Additionally, because all of the state information is part of the last block, there is no need to store the entire blockchain history.

Blockchain token systems have many applications ranging from sub-currencies representing assets such as USD ($) or gold to company stocks, individual tokens representing smart property, secure unforgeable coupons, and even token systems with no ties to conventional value at all, used as point systems for incentivization. The present embodiment may be considered a utility type token with intrinsic value. Extensions built on top of this embodiment could be reward or payment tokens.

In one embodiment, token systems are fundamentally a database with one operation: subtract X units from A and give X units to B, with the proviso that (i) X had at least X units before the transaction and (2) the transaction is approved by A. All that it takes to implement a token system is to implement this logic into a software contract. There are various programming languages available for writing Blockchain tokens or contracts, including Serpent, Solidity and others.

Advantageously, in various embodiments described herein, something intangible such as intrinsic value or resonance may be made more tangible, useful, measurable, impactful, valuable and more sharable. Applying the systems and methods of the embodiments described herein may make humans and companies far more satisfied and more fulfilled than ever before.

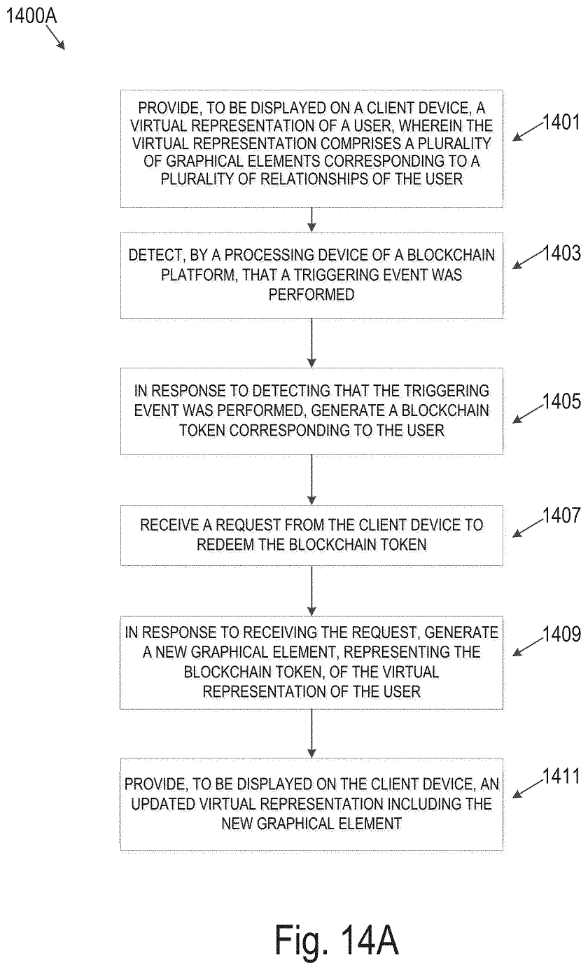

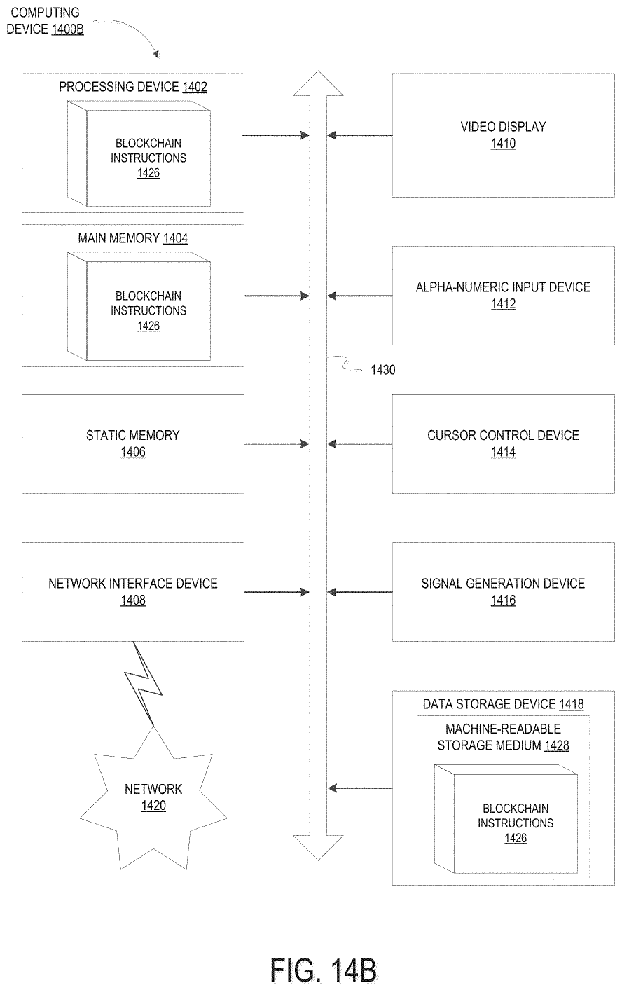

FIG. 14A is a flow diagram of a method for blockchain-based value platform operations, in accordance with some embodiments of the present disclosure. Method 1400A may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., 1400B illustrated in FIG. 14B).

Method 1400A may start at block 1401, wherein processing logic provides, to be displayed on a client device, a virtual representation of a user, wherein the virtual representation comprises a plurality of graphical elements corresponding to a plurality of relationships of the user. In one embodiment, the virtual representation includes a representation of a tree. At block 1403, processing logic detects, by a processing device of the blockchain platform, that a triggering event was performed. In one embodiment, processing logic may detect that the triggering event was performed by a sensor associated with the user. For example, a resonant sensor, a photoelectric sensor, a biometric sensor, or any other suitable sensor may be used to sense the triggering event, such as an emotion or state of being.

At block 1405, in response to detecting that the triggering event was performed, processing logic generates a blockchain token corresponding to the user. At block 1407, processing logic receives a request from the client device to redeem the blockchain token. At block 1409, in response to receiving the request, processing logic generates a new graphical element, representing the blockchain token, for the virtual representation of the user. At block 1411, processing logic provides, to be displayed on the client device, an updated virtual representation including the new graphical element.

In another embodiment, in response to detecting that the triggering event was performed, processing logic may generate a new graphical element (e.g., a branch of a tree), representing a relationship between the user and a third party, for the virtual representation.

In another embodiment, the new blockchain token further corresponds to the event and a third party (e.g., included metadata associating the token with the event and the third party, in addition to the user) and processing logic may further, in response to detecting that the triggering event was performed, generate a second blockchain token corresponding to: the user, the event, and the third party and send the blockchain token to the third party. In one embodiment, third party is an individual or an organization.

In another embodiment, processing logic may generate a physical token corresponding to the new blockchain token. For example, processing logic may send instructions to a machine of manufacture, wherein upon receiving the instructions, the machine of manufacture generates the physical token. Worth nothing, the number of blockchain tokens that may be issued by the blockchain platform may be unlimited.

The following paragraphs include numerous exemplary embodiments described with respect to various figures, each of which embodiments may be incorporated into the platform described herein either by themselves, or in any suitable combination.

### EXEMPLARY EMBODIMENTS

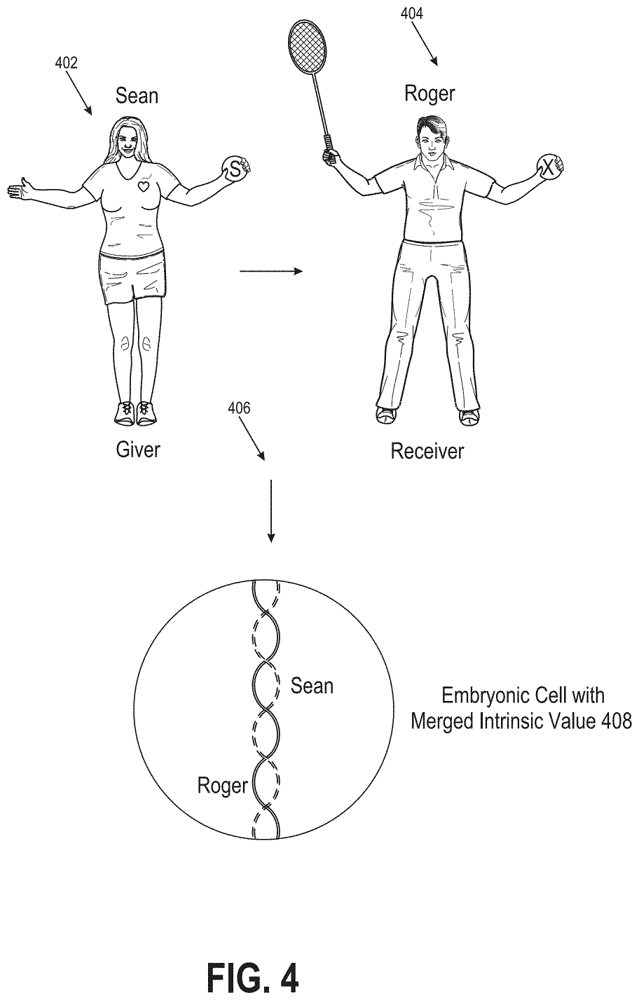

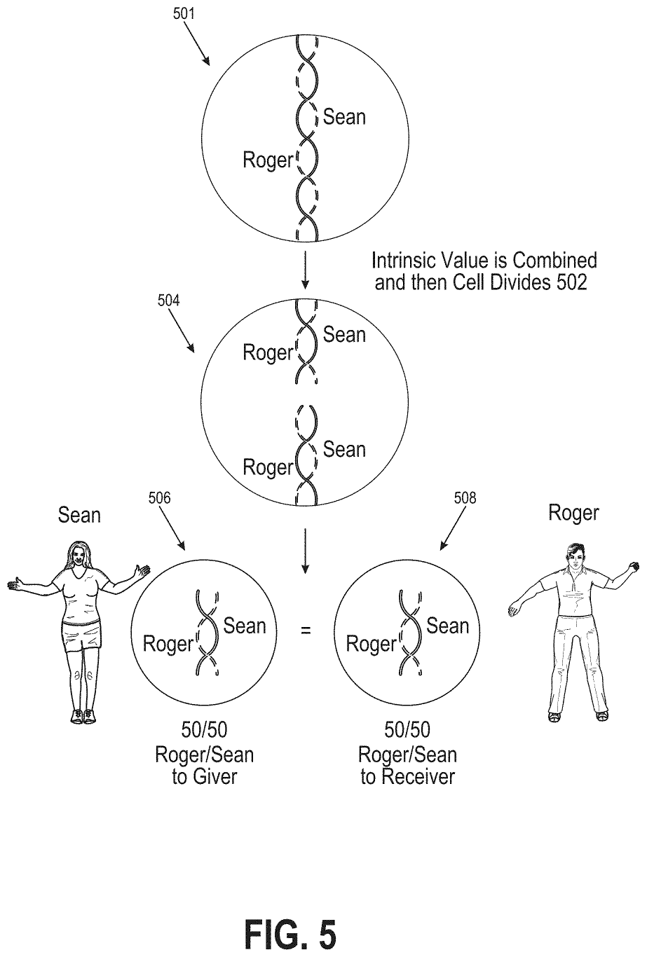

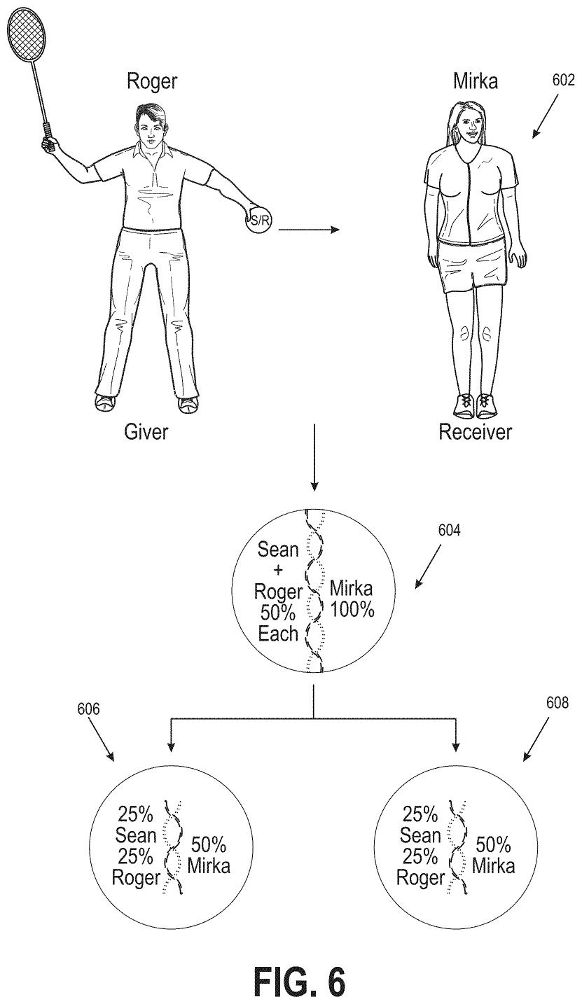

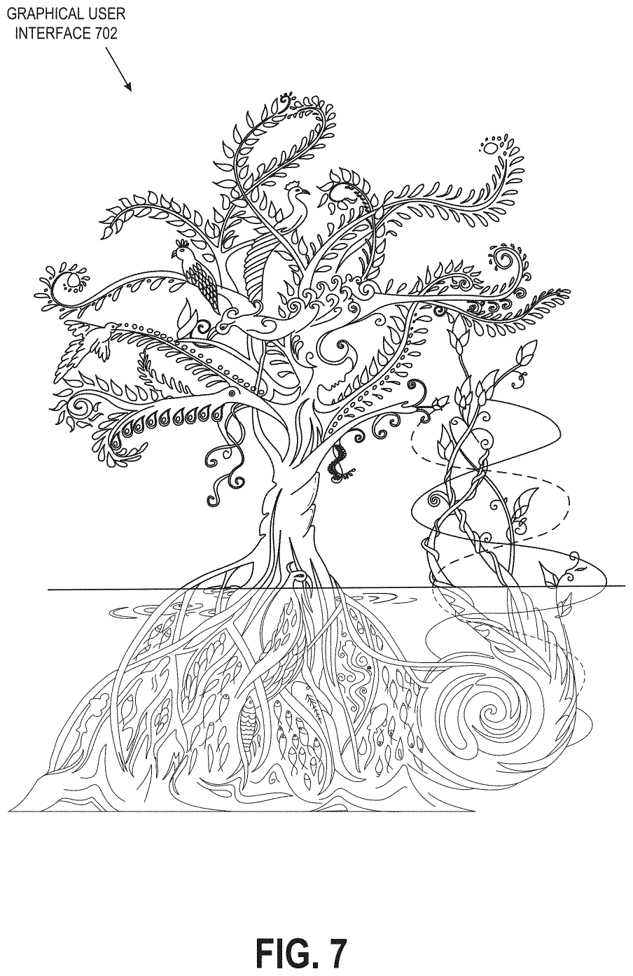

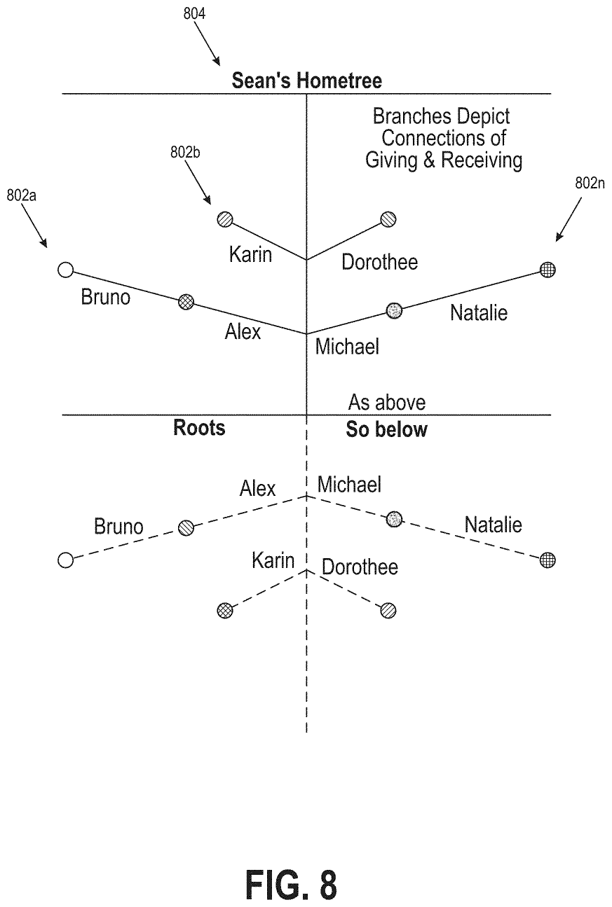

1. A method of virtual representation of an intrinsic value of a person or entity or organization.
2. The method of example 1 wherein the representation of intrinsic value is in the form of a digital asset (called a “Token”) on or in:
   i. the internet: or
   ii. blockchain data structure; or
   iii. software; or
   iv. network; or
   v. exchange; or
   vi. application; or
   vii. game.
3. The method of examples 1 or 2 wherein the representation of the Token of intrinsic value is in the form of a physical asset on:
   i. paper; or
   ii. plastic; or
   iii. fabric; or
   iv. metal; or
   v. stone; or
   vi. gem; or
   vii. wood; or
   viii. any physical medium; or
   ix. any combination of the above.
4. The method of example 1 and any combination of examples 2-3 wherein a person or combination of people or an entity or combination of organizations gives a Token representing their intrinsic value to another without selling or receiving anything in exchange or in return. Token is given as a gift.
5. The method of example 4, wherein the receiver accepts the gift from the giver resulting in the virtual identity and therefore membership to same or alternative platform in which the giver belongs to. Essentially, acceptance of the Token triggers membership of receiver to the platform, game or ecosystem.
6. The method of example 5, wherein the virtual representation of the intrinsic value of the newly created person or entity is “minted”. Acceptance of the Token gift results in virtual intrinsic value of the recipient being “created” in the platform.
7. The method of example 6, wherein some portion of the recipient's virtually represented intrinsic value is given back to the giver. A Token of intrinsic value of receiver is given back to the giver. See exchange 302 of tokens 304 and 306 in FIG. 3. After exchange 302 is executed, Sean is in possession of a Roger token 306 and Roger is in possession of a Sean token 304. The exchange may happen physically, with physical tokens, or digitally/virtually, in which case client devices would execute the exchange and store the respective tokens in memory.
8. The method of examples 1, 5 or 6, wherein the intrinsic value of both the giver 402 and the receiver 404 are combined 406 as if merged into a single embryonic cell 408 (as described herein, cells may be represented as tokens). See FIG. 4. A resulting merged token may be stored physically or digitally.
9. The method of example 8, wherein the cell 501 splits 502 as in cellular biology and divides into 2 identical “Stem” cells 504, each one containing 50% of the intrinsic values that went into the embryonic cell. One of the split stem cells 506 is returned to the giver and the receiver keeps the other one 508. Giver and receiver each have a matching Stem cell (506 and 508). See FIG. 5.
10. The method of example 9, wherein one of the stem cells opens up and releases 50% of the receiver and giver's intrinsic value.
11. The method of example 10, wherein 50% of the receiver's intrinsic value is given back to the giver.
12. A method of example 10, wherein 50% of the giver's intrinsic value is held by the receiver.
13. The method of example 9, wherein the receiver becomes a giver in choosing a new person or entity not yet a member of the platform in which to offer a Stem cell.
14. The method of example 13, in which the next receiver 602 invokes example 5. See FIG. 6. As, shown, stem sell 604 is split into two identical stem cells 606 and 608, each retaining properties of prior identities (e.g., prior givers and receivers).
15. The method of example 14, in which example 6 follows and any of examples 7-12. See FIG. 6.
16. The method, wherein any combination of examples 1-15 are repeated in perpetuity until the intrinsic value of every human and every entity on the planet are virtually connected or related on the platform.
17. The method of example 16, wherein an arbitrary limitation is placed on the number of persons and/or entities that can be strung together from an original Stem cell.
18. The method of example 1 or 5, wherein a person or entity chooses to create more Tokens of its intrinsic value by engaging with the platform and acquiring such Tokens in exchange for something of value to the platform.
19. The method, wherein a person or an entity gives one or more Tokens of their intrinsic value to another person or entity who is already a member of the platform.
20. The method of example 19, wherein additional intrinsic value is created for 1 or both parties in the exchange.
21. The method of example 20, wherein virtual intrinsic value is shared or exchanged between the two parties.
22. The method of examples 20-21, wherein this can only be allowed to take place once between each and every human and/or entity in the platform, resulting in maximal interconnections between all persons and all entities.
23. The method of example 1, wherein the player or user's intrinsic value is represented visually as a “HomeTree” 702 on a website, Blockchain, mobile app, a game, or in a virtual, augmented or mixed reality media, etc. See FIG. 7.
24. The method of example 23, wherein the player or user's connections are represented as branches (802a, 802b, 802n, etc.) on their HomeTree 804. The image is a “Family Tree” of connections. See FIG. 8.
25. The method, wherein a “Forest” of all the Home Trees in examples 23-24 can be seen by zooming out.
26. The method, wherein one or more or all HomeTree(s) examples 23-25 are connected to the primal “MotherTree”.
27. The method, wherein the MotherTree in example 26 is represented by the creator of these embodiments.
28. The method, wherein the MotherTree in examples 26-27 is virtually rooted/planted in the “Eternal Forest”.
29. The method, wherein the MotherTree in examples 26-28 is considered to be made of petrified wood.
30. The method, wherein the MotherTree in examples 26-29 is virtually rooted/planted in a not-for-profit organization, e.g., the MotherTree Foundation.
31. The method, wherein a physical tree on Earth is identified or planted to physically represent the value of the virtual MotherTree described in examples 26-30.
32. The method, wherein HomeTree(s) get “Composted” when the person connected to them physically dies or the company they are connected to is shut down or acquired. Composting is further described in the Claims for “Token of Me” game described below.
33. The method, wherein A player or user may donate his/her Home Tree to the Eternal Forest where it will live forever and be looked after by the MotherTree Foundation.
34. A method of example 1, wherein the player or user's intrinsic value is represented visually as a “Spaceship” on a website, Blockchain, mobile app, a game, or in a virtual, augmented or mixed reality media, etc.
35. A method of example 34, wherein the player or user's connections are represented as a pod or fleet of Spaceships related or belonging to a larger “Mothership”.
36. A method of example 1, wherein the player or user's intrinsic value is represented visually as a “Bee” on a website, Blockchain, mobile app, a game, or in a virtual, augmented or mixed reality media, etc., and the player or user's connections are represented as honeycombs in a “Bee Hive” overseen by a “Queen Bee”.
37. A method of example 1, wherein the player or users intrinsic value is represented visually as a “Bird” on a website, Blockchain, mobile app, a game, or in a virtual, augmented or mixed reality media, etc., and the player or user's connections are represented as birds flying in formation with a nest overseen by a “Mother Bird”.
38. A method of example 1, wherein the player or users intrinsic value is represented visually as any animal on a website, Blockchain, mobile app, a game, or in a virtual, augmented or mixed reality media, etc.
39. A method of example 1, wherein the player or users intrinsic value is represented visually as an “Avatar” of you, a character representing you.

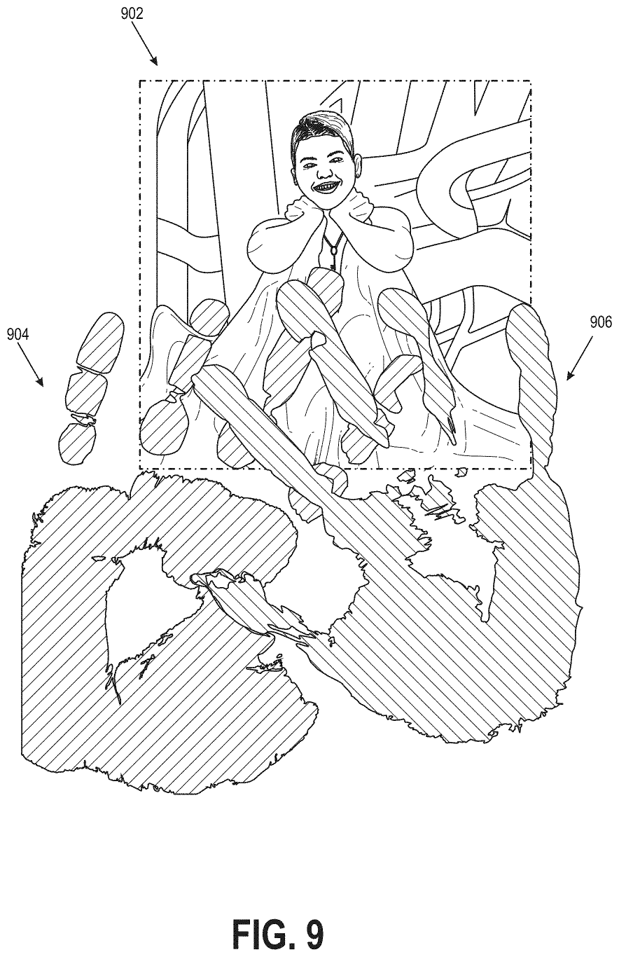

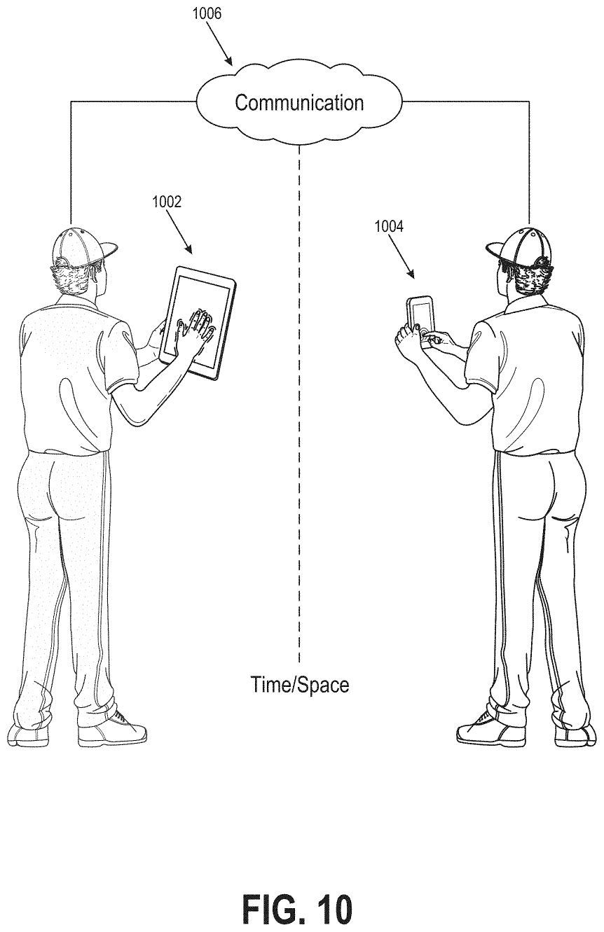

Example embodiments of playing a game (Tree of Life) as described herein:
Each player has a Home Tree to represent their intrinsic value.
Each player's Home Tree represents their Family Tree of connections and branches to others.
Each player receives Tokens or Seeds whenever they perform a service that creates intrinsic value as determined by the game.
Seeds can be planted in your own virtual garden or in other's gardens or in the Commons (under the MotherTree).
The goal of the game is to figure out how to realize and optimize your intrinsic value and then go public, i.e. sell or exchange your tokens, in order to realize your life's purpose and intentions.
All names, as used herein using all capital letters, are merely for example and any other name or designation may be used in their place.
1. A method by which a person or legal entity gives a “Token” representing their intrinsic value to another person or legal entity. For example, SEAN (the “Giver”) gives a Token of her intrinsic value to MICHAEL (the “Receiver”).
   A. In person.
      (1) A photo/drawing 902 on a piece of paper representing your intrinsic value given to another and the same in return. See FIG. 9.
         (a) Both parties sign or apply hand print (904 and 906) on the Givers Token, and/or
         (b) Both parties sign or apply hand print on the Receiver's Token;
         (c) Take a photo of both parties together holding each other's Token.
         (d) Include GPS info from both mobile phones to validate mutual location.
         (e) Submit the photo to the Blockchain platform to validate using facial recognition or by any other suitable authentication/validation operation.
   B. By mobile phone.
      (f) Both parties use a password and/or biometric method to validate the Token exchange or membership invitation, e.g., iris scan, thumb or hand, voice or any combination thereof.
   C. Combination of in person and mobile phone.
      (2) Mutual and verifiable attendance to same event (e.g., concert) at same time/space.
         (g) The person on stage offers a Token to the audience.
         (h) The Receivers in the audience take a selfie photo of themselves with a live image of the Giver on the stage projected on a screen along with a Q code projected on the screen to capture the time, place and identity of the Giver.
         (i) This photo is submitted to a token Blockchain platform to validate the Giver and Receiver and confirm the time and place with GPS info.
         (j) Witnesses who attended the event can be used to further validate the Token exchange.
   D. By email.
   E. By mail.
   F. By website and therefore through any computing device. See client devices 1002 and 1004, communicating via a server/cloud platform 1006 of FIG. 10. In one embodiment, client device 1002 may validate/authenticate a transaction using handprint identification technology and client device 1004 may validate/authenticate a transaction using fingerprint identification technology. In other embodiments, any other suitable technologies may be used.
   G. By link invitation to a website and therefore through any computing device.
2. The method of example 1 wherein the Token is a gift, not sold, borrowed, or loaned. There is no promise or expectation of each other or debt implied in this transaction.
3. The method of example 1, wherein the offer of a Token is an invitation to join a platform, game, ecosystem or financial system,
4. The method of example 3, wherein Receiver's (MICHAEL) acceptance of a Token from Giver (SEAN) results in receiver's acceptance/membership to a token platform, Blockchain, game, ecosystem, or financial system.
5. The method of example 3, wherein the Receiver's acceptance of a Token from Giver results in a virtual representation of Receiver's “HomeTree” (e.g., MICHAEL's HomeTree)
6. The method of example 5, wherein Receiver is represented as a “Branch” on Giver's HomeTree. The Branch could be further represented in chronological order from the top down whereby new branches are added above lower ones and the Giver's Home Tree trunk must then grow taller in order to make room for new Branches to stem out from his/her tree “Trunk” as all connections are represented as Branches on one's HomeTree. For example, SEAN's HomeTree now has a MICHAEL Branch on it.
7. The method of example 5, wherein the Receiver becomes a Giver of his/her Token to a new person or entity (2^{nd} Receiver) not yet on the Blockchain platform, e.g., NATALIE.
8. The method of example 7, wherein the 2^{nd} Receiver (NATALIE) results in the MICHAEL Branch on the previous Giver's Home Tree (SEAN's) extending further on the Branch of the 1^{st} Receiver (MICHAEL). The MICHAEL Branch on SEAN's Home now has a NATALIE point, from which the MICHAEL Branch extends further with NATALIE at the furthest most tip of the MICHAEL Branch. When NATALIE gives a Token of herself to someone new, the MICHAEL-NATALIE Branch on SEAN's HomeTree extends further from the NATALIE point to all persons or companies that NATALIE gives to and are received by them. Every Branch point on SEAN's HomeTree is an entire HomeTree of someone else stemming from SEAN.
9. The method of examples 6, 7, and 8 wherein a new NATALIE Branch on MICHAEL's

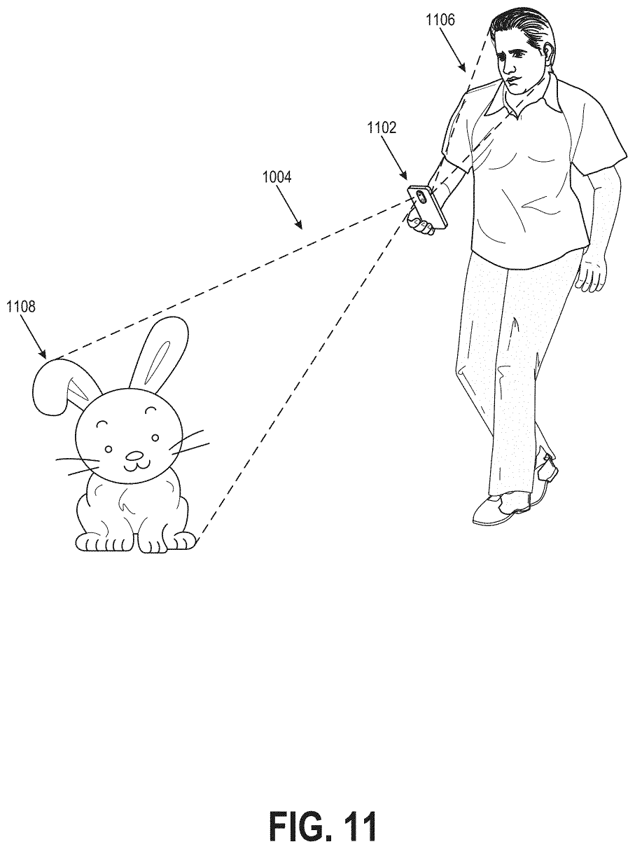

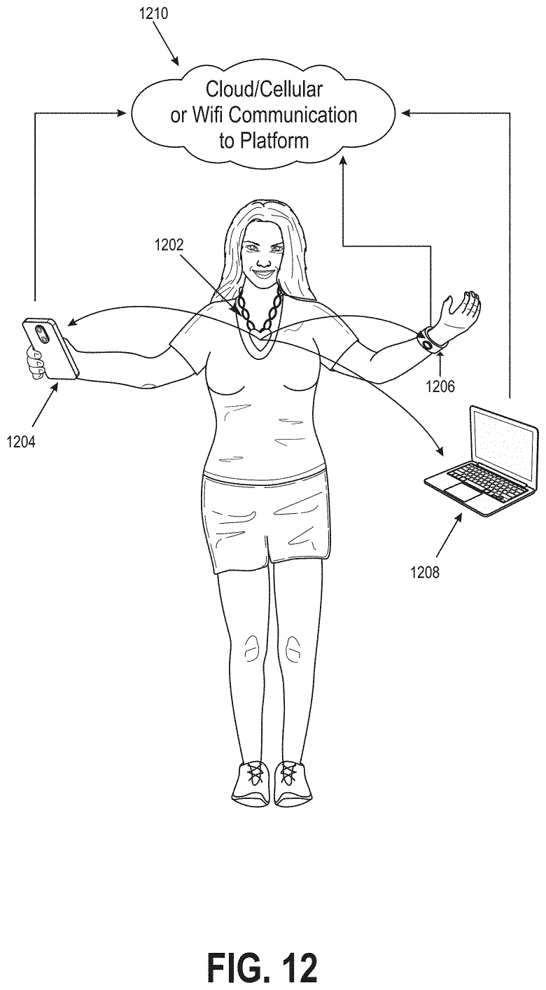

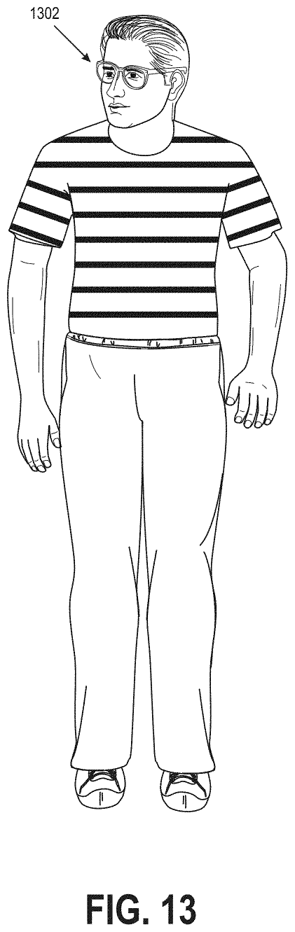

Home Tree is established. When NATALIE gives a Token of herself to someone new, this NATALIE Branch on MICHAEL's HomeTree extends further from the NATALIE Branch to all persons or companies that NATALIE gives to and are received by another. Every Branch point on MICHAEL's HomeTree is an entire HomeTree of someone else stemming from MICHAEL.
10. The method of example 8 wherein the N^{th} Receiver results in further explosions at Branch tips of the prior N-1 Giver on the HomeTree of N-1 and all Home Tree connections stemming from that which led to the N Branch on N-1 HomeTree. All of the Each person or company can zoom in/out on the Branches of their HomeTree to see their connections. All the Branches are kept in visual proportion to represent a balanced HomeTree.
11. The method of any of examples 1-10, wherein one's Hometree is literally a representation of ones “FamilyTree” of relationships and connections.
12. The method of any of examples 1-11, wherein each HomeTree is reflected below the surface as a mirror image of its “Roots”. As above, so below. The Roots represent that which is invisible, your intrinsic or inner value or potential.
13. The method of any of examples 1-12, wherein one's HomeTree can be represented as any type of tree, e.g., African Tulip, Ginkgo Biloba, etc.
14. The method of any of examples 1-13, wherein one's HomeTree flourishes above as its Roots are nurtured and tended to below through appreciation and alignment or resonance with Source or your Intentions.
15. The method of any of examples 1-14, wherein intentions can be virtually planted using Seeds in your Garden at the base of your HomeTree.
16. The method of any of examples 1-15, wherein one's HomeTree can be nurtured through appreciation of each other or all things already manifested in the physical realm.
17. The method of any of examples 1-16, wherein one's HomeTree can also be nurtured through meditation or imagination and deliberate thought experiences not yet manifested physically, but felt vibrationalty.
18. The method of any of examples 1-17, wherein when a user deliberately and consciously appreciates anything, this flow of positive energy shall manifest itself as “Sunshine” on their own HomeTree or biofuel in the “Love Tank” of your Spaceship Pod or honey in your Bee Hive or worms or insects to attract birds.
19. The method of any of examples 1-18, wherein when a user deliberately and consciously directs appreciation to another person or company, this flow of positive energy shall also manifest itself as Sunshine on the “Target” person/company HomeTree and biofuel in their Love Tank. Furthermore, a “Leaf” shall appear on all the Branches on every HomeTree between the Sender and the Target Receiver. If the Receiver is not on the FamilyTree of connections represented on the Sender's HomeTree, the Receiver shall receive “Rain and/or Dew Drops” or “Pollen” on their HomeTree. In addition, these Rain Drops or Dew Drops or Pollen may appear on all HomeTrees leading back up the Family Tree of connections from the Sender all the way back to the MotherTree (Sean's Home Tree) and then back out on all the Branches leading to the Target Receiver.
20. The method of any of examples 1-19, wherein when a user deliberately and consciously appreciates a person or company not yet on the platform, the energy is stored as potential for that person or company to be realized and released once they do join. When they do, Leaves are manifested on all the FamilyTree of connections and Rain/Dew Drops or Pollen on all the HomeTrees indirectly connected.
21. The method of any of examples 1-20, wherein when a user deliberately and consciously appreciates something other than a person or a company (e.g., nature, animals, the ocean, the sun, etc.) the energy may be stored in virtual silos or potential HomeTrees for these Recipients.
22. The method of any of examples 1-21, wherein when a user deliberately and consciously appreciates anything, they receive a universal Token representing the intrinsic value of Source energy (called “Token of Me” or “TOM”). This is the way intrinsically valued Tokens are “Mined” or “Farmed”. A user may have to pay something for this Token of Me, e.g., penny for your thoughts. In another embodiment, the user does not pay anything for these Tokens. Alternatively, these tokens may be worth a penny when you cash them in for YOUR personal Tokens SEAN, MICHAEL, DOROTHEE, ALEXANDRA). All variations are covered in this claim since we don't yet know what will be the most effective.
23. The method of any of examples 1-22, wherein alternatively, a user may receive a Token of “YOU” (e.g., themselves—SEAN, MICHAEL, DOROTHEE, ALEXANDRA) in response to appreciating anything.
24. The method of any of examples 1-23, wherein alternatively, a user may receive a Token of the Target Receiver (e.g., SEAN, ALEX, MICHAEL, DOROTHEE, ROGER, APPLE COMPUTER, RED CROSS) when the user deliberately appreciates that person or company.
25. The method of any of examples 1-24, wherein whether a user is using universal Tokens (e.g., TOM) or Tokens of YOU (e.g., themselves—SEAN, MICHAEL, DOROTHEE, ALEXANDRA, ROGER), the user could move to the next level of game playing by using these when you deliberately and consciously appreciate others or anything.
   A. Create/Give Flowers or Pollinate. When you deliberately and consciously focus your appreciation on another person and optionally back this up or combine it with a TOM Token or Token of YOU, this would result in a “Flower” showing up on the Target Receiver's HomeTree and possibly all the corresponding Branches on all the HomeTrees between you and the Target. If the Target is not connected to your HomeTree, then a “Bee” is manifested to “Pollinate” Flowers on all the Branches of the HomeTrees leading back up your FamilyTree to the MotherTree and then down all the Branches until the Sender's HomeTree is reached.
   B. Plant Seeds. When you deliberately and consciously focus your appreciation on something other than a person, such as an Intention or Idea, and optionally back it up with a TOM token or Token of YOU, this spawns another flow of creation . . . a Seed Token
      (1) You can plant Seed Tokens or Seeds of Intention in your Garden at the base of your HomeTree, or)
      (2) You can plant your Seed Tokens or Seeds of ion in the Garden(s) of other HomeTrees.
      (3) Either way, this is your way of expressing your intentions and who you value and what you value and where you wish to invest or plant your intrinsic value.
   C. Bear Fruit/Vegetables (Commons). When you deliberately and consciously focus your Intention on a Common Value, e.g., removing plastic from the ocean, encouraging the growth of coral reefs, planting trees, carbon offsets, aiding refugees, etc., and you optionally back these Intentions with a TOM token or Token of YOU, these are planted in the Common Garden under the MotherTree and may be represented by Fruit or Vegetables, Plants or Vines, e.g., passion flower vine with passion flowers and passion fruit full of Seed Tokens, blooming sunflowers with Seed Tokens.
   D. Bear Fruit/Vegetables (Personal). When you deliberately and consciously focus your Intention on a personal Intention or Idea, e.g., new embodiment, new job, etc., and optionally back these Intentions with a TOM token or Token of YOU, these are planted in your Garden under your HomeTree and may be represented by Fruit on your HomeTree or Vegetables, Plants or Vines in your Garden.
   E. Spreading Seeds. Anyone can spread and share their Seed Tokens in other Gardens as a way of expressing and amplifying their appreciation or investing or contributing to other's Intentions or Ideas. Seeds could be seen distributed by birds to other HomeTrees in your local forest or by travel in your Spaceship Pod around the globe to colonies farther away.
   F. Weather Patterns. You can zoom out from your HomeTree and see other HomeTrees in your vicinity and in your immediate Forest. Keep zooming out to see other Forests. Using your Spaceship Pod, you can fly higher and around the world and get a visual on where Seeds of Intent are flowing. The flow of appreciation and intrinsic value manifesting as Leaves, Flowers, and Seeds being invested can be seen as weather patterns to locate the “Hot Spots” of intrinsic value or flow of Source energy.
   G. Hot Spots could be represented as “Hurricanes of Grace” or “Volcanic Eruptions” or “Earthquakes” or “Avalanches”. The farther away are the connections and/or the more Seed Tokens deposited/planted in a given Garden, the larger and wider the hurricane, eruption, earthquake or avalanche is represented on a map of the world.
26. The method of any of examples 1-25—This event may be represented as leaves falling to the ground as in the Fall season. The leaves may even begin to turn brighter colors as this Fall number is approaching. Once they do fall to the ground, a blanket of snow may fall on your HomeTree, The Leaves/Flowers underneath are composted/converted into Realized Tokens of YOU that can be sold or traded publicly on an exchange. Anyone who you have given Seed Tokens of YOU to now has Realized Tokens of YOU that they too can sell on the exchange for street fiat money or any other digital token. Realized Tokens of YOU may be backed by Share(s) or security tokens in the for-profit platform, especially if your HomeTrees have been donated to the Foundation.
27. The method of any of examples 1-26, wherein investors compete with the underlying for-profit platform and donors compete with a not-for-profit Foundation to buy Intentions planted in the Common Garden and/or personal Gardens. Those who fund Intentions with street money or any other digital tokens, receive the Seed Tokens and/or Realized Tokens and/or generalized TOM Tokens of the players who donated/contributed to those Intentions/Embodiments, which can be sold or traded when the inner value of these Tokens is realized. Alternatively, the ownership interest in the Intention or Embodiment could also be partially or fully reflected proportionately by the Tokens planted in the Intention or Idea. If the Foundation buys Intentions planted in the Common Gardens or personal gardens, she can sell Shares or security tokens in the for-profit platform (if necessary) to raise street fiat money to make these acquisitions.
28. The method of any of examples 1-27, wherein if you don't play the game for a while (some threshold amount of time), your HomeTree will not get any Sunlight and will begin to wither from lack of attention and therefore lack of Sunshine and Rain.
29. The method of any of examples 1-28, wherein when a user physically dies, the user's HomeTree falls and begins to compost. In doing so, all the Leaves and. Flowers still on your Home Tree are distributed to those on your Branches in proportion to how many Tokens of YOU they have; or in proportion to how many Tokens of YOU you have given to those on your Branches during your lifetime. Alternatively, all the Leaves and Flowers on your HomeTree could be distributed to all the Seeds of Intentions in your Garden. In the Composting process, all of your Tokens could become realized and sold/exchanged on the public market. Some kind of validation process confirming a Death Certificate will be required before Composting begins.
30. The method of any of examples 1-29, wherein if you donate or designate your HomeTree to the MOTHERTREE Foundation, upon your physical death, your HomeTree will not compost, but will live eternally in the Eternal Forest and be maintained by the MOTHERTREE Foundation to live out your wishes. Your HomeTree may continue to receive appreciation and if/when enough Leaves have grown and/or Flowers have bloomed to trigger a Fall season, the MOTHERTREE Foundation shall reap the benefits of your Realized Tokens by selling and/or donating them in accordance with the wishes of your legacy.
31. The method of any of examples 1-30, wherein mining or farming is accomplished through many forms of validation. One way is to use a mobile phone app, computer app or website portal intended to be the conduit for flowing your appreciation and therefore Source energy to a Recipient, which could even be yourself.
   A. Mobile App Text/Voice. A method by which you enter a text or voice message of appreciation on a mobile device and send it to the token platform or a particular HomeTree on the platform. This text or voice message would contain certain features or elements that would either raise your vibration or release resistance as described in more detail below. In doing so, Source energy full of intrinsic value is summoned and flows. This flow may be represented as a satellite dish receiving or transmitting this energy to you or your Spaceship Pod or your Avatar, or HomeTree and resulting in Leaves, Rain, Dew, Sunshine, Flowers, Pollen, Seeds, Tokens, Biofuel, Honey, etc. as describe herein. Simultaneously, the camera on the mobile phone takes your photo or at the very least validates who is submitting the text or voice message. This provides validation of who is doing the appreciating. Alternatively, the identity validation could be biometric input (e.g., thumb, finger, hand, voice, iris scan). Here are some examples of the contents of the text or voice messages:
      (1) General appreciation of anything, including a positive thought about something or someone and holding it and feeling it for at least 17 seconds.
      (2) Taking something unwanted and finding the value or benefit in it.
      (3) Taking 2 seemingly opposing thoughts and finding a way to unionize them.
   B. Mobile App Camera/Video. The mobile processor on a mobile phone 1102 could activate the camera feature and open the camera lens on one 1104 or both sides (1104 and 1106) of the mobile phone 1102. You could take a photo or video of something you appreciate or that triggers your appreciation (e.g., 1108) for something wanted or valued. Simultaneously or consecutively, the camera takes your photo 1106 or at the very least validates who is taking the picture/video of what the camera is pointed at on the opposite side 1104. This provides validation of who is doing the appreciating of what. Alternatively, the identity validation could be biometric input (e.g., thumb, finger, hand, voice, iris scan). The photo/video is sent to the token platform to trigger Leaves, Rain, Dew, Sunshine, Flowers, Pollen, Seeds, Tokens, Biofuel, Honey, etc. as describe herein. See FIG. 11.
   C. HeartMath Device. HeartMath has a device you clip to your ear lobe and clip the other end to your shirt or rest over your heart. This device measures your Heart Rate Variability (HRV) which corresponds to the coherent vibration of your heart beats. When you are focused on appreciation, your HRV is more coherent in a smoother sinusoidal signal rather than an irregular jagged signal representing negative thoughts and feelings. Coherency and therefore alignment with Source can be measured and validated using the HeartMath mobile app, including the percent of coherency over any period of time. Any time spent achieving a coherent state as confirmed with a HeartMath or similar device that measures HRV, could result in triggering a digital token. In the spirit of the particular game or application surrounding the tree of life, HRV coherency could result in Leaves, Rain, Dew, Sunshine, Flowers, Pollen, Seeds, Tokens, Biofuel, Honey, etc. as describe herein.
   D. HeartField Coherency. In one embodiment, diamonds may be manufactured with nitrogen defect “holes.” The spin of electrons in these holes are extremely sensitive to energy fields even at room temperature. In one embodiment, a simple device 1202 may be worn like a diamond pendant on a necklace that can pick up and resonate with your magnetic heart field when you are in a high state of coherency (appreciation/love). Simple additional electronics e.g., client devices 1204, 1206, 1208) can amplify and/or convert this to electrical energy and transmit this information when you are in alignment with your Source energy. This resonance can be picked up or transmitted to your mobile phone 1204 or watch 1206 or any nearby receiver 1208 and transmitted to the token platform through a Wi-Fi or cellular network 1210. You could earn Tokens in return based on length of time in alignment. This would be one way in which “Proof of Alignment” or “Proof of Resonance” is achieved. See FIG. 12.
   E. Other Sensor Varieties (“Flow Sensors”). In addition to heart-field coherency as measured by a resonant magnetic field detected by nitrogen-doped diamonds or heart-rate variability using a Heartmath device, for example, a variety of other sensors may be used to measure a flow state of being to result in triggering a token/reward, e.g., flow, alignment, resonance, coherency, lowered resistance, higher vibration, brain waves, lowered skin resistance, goosebumps, etc. The embodiments described herein encompass any measurement of the human body using any kind of wearable device (e.g. necklace, pendant, earrings, bracelet, watch, ring, headband, helmet, wristband, glasses, sun-glasses, clothes, gloves, shoes, wearable patch, body injected or digested device, etc.) or using any measuring device that humans touch, such as steering wheels, sports equipment, mobile phones, computer equipment, furniture, chairs, vehicles, etc. A token reward is created/issued for achieving intrinsically valuable states that can be considered to be evidence of alignment, resonance, coherency, lowered resistance, higher vibration, states of flow. Such measurements may be distinguished from other body measurements for different purposes: sleep cycles, number of steps taken in the day, blood sugar levels, insulin levels, good driving behavior (as measured in steering wheels), etc. The wearable devices contemplated herein may be distinct from wearable devices using other body sensors that may be used to trigger rewards for other reasons, e.g. such as discounts on a person's insurance. The examples described herein are also distinguished from rewards issued as a result of self-reporting efforts or attempts to achieve such states without measurements. For example, there may be applications that will reward a person for meditating or exercising, but these either rely on self-reporting that did something (regardless of achieving results) or simply going through the motions. For the embodiments described herein, results matter, not just intention or going through the movements.
   F. Visual Coherency. The same type of nitrogen spin sensitive diamonds or Flow Sensors as described above could be embedded in the frame or on the lens of eye glasses 1302. In addition to picking up your heart or brain field coherency and therefore alignment with Source, this device could also allow more brilliant light to flow in/out of the glasses in front of your vision. What you see would literally be brighter, more colorful, sharper, or more clear. When you are NOT in alignment, your view would be duller, dimmer, darker, grayer, or less colorful. In other embodiments, light-emitting diodes, heads-up displays, or other visual feedback technologies on the glasses 1302 may be used. The wearer would have instantaneous visual feedback of his/her alignment. The resonance could be picked up by a mobile phone or any receiver and transmitted to the token platform (e.g., see FIG. 12). You could earn Tokens in return based on length of time in alignment. This would be another way in which Proof of Alignment or Proof of Resonance or Proof of Flow is achieved. See FIG. 13.
   G. Transparent Coherency. The same type of nitrogen spin sensitive diamonds or Flow Sensors as described above could be embedded in a necklace, a pendant ring, watch or any wearable device, including clothing, e.g., hat, belt, shield, etc. Whenever you are in resonance with your Source, the diamond holes will either glow naturally or with the help of LEDs and thereby transparently indicate resonance of the person wearing or holding the radiating device. This would be particularly useful in personal and/or professional interactions wherein the parties would transparently reflect their alignment (or lack thereof) in real-time. One would instantly know if the thought they just received was in alignment with their Source or under some other influence. Such a device would indicate the highest integrity and higher intrinsic value. Another use for such a device would be to know when you are in alignment before working or performing, competing or doing anything. Only take inspired action.
   H. Brainwave Coherency. Just as described above, similar Flow Sensors or nitrogen embedded diamonds worn around your head (e.g., glasses, hat, etc.) can pick up and resonate with positive coherent brainwave vibrations trigger by positive or resonant thoughts. Alternatively, such a device could pick up on your “quiet” brainwave pattern and associate this with literally quieting your mind (fewer thoughts) or based on certain patterns representing resonance or alignment with Source. This could be further validated if you also have a Heart Coherency device to correlate this achievement with further evidence and validation. You could earn Tokens in return for this alignment. This would be yet another way in which Proof of Alignment or Proof of Resonance or Proof of Flow is achieved.
   I. Meditation. A user may receive Tokens by aligning with Source energy through meditation. There are many methods by which this is possible:
      (4) Meditation.
      (5) Listening to audio files.
      (6) Watching videos.
32. The method of any of examples 1-31, including Viral Membership. The giving and receiving of your own token as the exclusive and inclusive method by which members are invited to join the token platform. To give is to receive. This naturally triggers love or appreciation and therefore intrinsic value. You cannot buy your way in. Invite only membership through a token gift.
33. The method of any of examples 1-32, including In-Person Invite/Acceptance. Acceptance of a token membership invitation performed in person rather than online or remotely to establish the greatest value and trust between members, particularly in creating the backbone or foundation of the token platform.
34. The method of any of examples 1-33, including Hand Acceptance. A method by which your entire hand-print is your validation rather than signature or thumb/finger print.
35. The method of any of examples 1-34, including Biometric Validation. A method by which you, your tokens or your intentions are validated by biometric data, e.g., your iris scan, hand-print, voice, etc., and thereby avoiding any need to remember or write down complex private keys which are vulnerable to being lost, stolen or hacked.
36. The method of any of examples 1-35, including Seed Bank. A method by which players Seeds or Tokens are deposited into a virtual Seed Bank with different “Intentions” that represent different Accounts and when a particular Account is funded or bought, all of the Seeds go to the buyer OR . . . all the Seeds or Tokens represent proportional investment ownership in whatever germinates from the Intention. For example, if the MOTHERTREE Foundation does the funding/donating, the new venture could be partially owned by the Seed investors. This will encourage members to “invest” in other member's new ideas, embodiments and businesses within the platform and thereby create a more diversified network of investments within the platform or ecosystem. When the tide rises, all the boats rise. We are all in this together. Win-win.
37. The method of any of examples 1-36, including Resonant Devices. Many of the examples in the tree of life game described above, including but not limited to Claims 31(A-H), could also be stand-alone Claims for their own benefit outside the game and/or used to prove that a state of alignment or resonance has been achieved for use in any other application.
38. The method of any of examples 1-37, including Alloy Tokens. Combining different values or assets into a single Token, such as a Token backed by one gram of gold plus one gram of silver, or one token of Ethereum (ETH) plus one token of Bitcoin (BTC) into one combined Token containing both (e.g., ETHBTC). A method of combining the intrinsic values of multiple people (e.g., ROGER+TUFA, SEAN+MICHAEL, SEAN+ALEXANDRA, or all team members of French Football World Cup winner). A method of combining the intrinsic values of companies or organizations into a single token (e.g., Red Cross or Make-A-Wish Foundation plus the MOTHERTREE Foundation). A method of representing virtual alloy tokens with one side represented by one value and another value on the other side . . . there are 2 sides to every coin (e.g., ROGER on top or left, RAFA on the bottom or right).
39. The method of any of examples 1-38, including Physical Tokens. Physical coins, plastic cards or even paper issued to replace and/or represent digital blockchain tokens. The making of a real tangible object to represent a virtual or intangible token of value. The embedding of the hash tag of a token block into a physical object. The destroying or virtual burning/melting of a virtual digital token on the Blockchain once a physical version has been constructed. The assigning ownership of the physical token to a particular person or legal entity by any method including the use of biometric data, programmable ID chips, etc. A method of going back the other way from physical to virtual tokens. A method of making commemorative Token Alloys (e.g., ROGER/RAFA) and biometric ownership matched with II) chip programmed to go with the owner of such a Token Alloy. A method of physical tokens with one side represented by one value and the another value on the other side . . . there are 2 sides to every coin (e.g., ROGER on top, RATA on the bottom).
40. The method of any of examples 1-39, including Backing Tokens. The backing of digital or physical tokens, including Alloy Tokens, with something else of value. This is similar to Alloy Tokens, but the addition is that you attach smart contract(s) to tokens, such as the promise to buy them or exchange them for something else, or provide collateral for them. This provides “backing” to ensure the minimum value of such tokens. For example, TOM tokens or Tokens of YOU could be backed by MOTHERTREE tokens. In another example, Roger Federer could back his tokens by attaching the value of his trophies to his tokens or anything else he can think of.
41. The method of any of examples 1-40, including Bankruptcy Protection. Bankruptcy insurance in the event your tokens bottom out in value.
42. The method of any of examples 1-41, including Token Insurance. Insurance for Blockchain Tokens in case you get hacked or lose valuable access information to your account or can't remember your password.
43. The method of any of examples 1-42, including Charging/Storing Good Vibes. Charge the resonating diamonds described above to literally store the good vibes programmed into them from a person in a heightened state of alignment or in resonance with their Source. Such a device can be worn like a necklace, watch or glasses to radiate good vibes to help you stay in alignment.
44. The method of any of examples 1-31, including Quantum Entanglement. Through quantum entanglement, a user may share their good vibes with others by directing these vibrations to other resonating diamond devices worn by others who wish to receive and stay connected to you. This would be desired by a couple engaged to be married, for example. Their diamond rings would literally radiate their love for each other. This would make manufactured diamonds more valuable than naturally mined diamonds and thereby clean up the dirty diamond business. The manner in which these resonating diamonds could stay connected would be through quantum entanglement even from a physical distance. Perhaps they are programmed/charged together and are then split apart.

Worth nothing, any reference to “you” as described herein, may be contemplated to be the user of the game, platform, system, etc. “You” is used herein merely for clarity and brevity. Furthermore, any reference to creating, exchanging, merging, splitting, storing, etc. tokens may be in reference to physical tokens and/or digital tokens exchanged and stored by client devices, servers, and/or cloud infrastructures.

FIG. 14 is a block diagram of an example computing device 1400B that may perform one or more of the operations described herein, in accordance with some embodiments. Computing device 1400B may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1400B may include a processing device (e.g., a general purpose processor, a PLD, etc.) 1402, a main memory 1404 (e.g., synchronous dynamic random access memory (DRAM), read-only memory (ROM)), a static memory 1406 (e.g., flash memory and a data storage device 1418), which may communicate with each other via a bus 1430.

Processing device 1402 may be provided by one or more general-purpose processing devices such as a microprocessor, central processing unit, or the like. In an illustrative example, processing device 1402 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1402 may also comprise one or more special-purpose processing devices such as an application specific integrated circuit (ASIC), a field programmable gate array (FPGA), a digital signal processor (DSP), network processor, or the like. The processing device 1402 may be configured to execute the operations described herein, in accordance with one or more aspects of the present disclosure, for performing the operations and steps discussed herein.

Computing device 14008 may further include a network interface device 1408 which may communicate with a network 1420. The computing device 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse and an acoustic signal generation device 1416 (e.g., a speaker). In one embodiment, video display unit 1410, alphanumeric input device 1412, and cursor control device 1414 may be combined into a single component or device (e.g., an LCD touch screen).

Data storage device 1418 may include a computer-readable storage medium 1428 on which may be stored one or more sets of instructions, e.g., instructions for carrying out the operations described herein, in accordance with one or more aspects of the present disclosure. Blockchain instructions implementing component (to execute any of the operations described herein) 1426 may also reside, completely or at least partially, within main memory 1404 and/or within processing device 1402 during execution thereof by computing device 1400, main memory 1404 and processing device 1402 also constituting computer-readable media. The instructions may further be transmitted or received over a network 1420 via network interface device 1408.

While computer-readable storage medium 1428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

The various components of embodiments described herein may comprise various construction materials. For example, each of the components may be constructed from injection mold plastic, 3-D printed plastic, wood, fiberglass, metal, cardboard, foam, rubber, carbon fiber, etc. Various coatings and/or coverings such as felt, velvet, rubberized paint, plastic, PVC, glass, foam, etc., may be applied to a base construction material to form the final components. Furthermore, any fastener type may be used in place of the fasteners described herein for convenience.

In the description herein, numerous specific details are set forth, such as examples of specific hardware structures, specific architectural and micro architectural details, specific components, specific measurements/heights, etc. in order to provide a thorough understanding of the present disclosure. It will be apparent, however, that these specific details need not be employed to practice the present disclosure. In other instances, well known components or methods, such as specific and alternative construction materials, dimensions, shapes, sizes, functions and other specific details of the various versions of the apparatus described herein have not been described in detail in order to avoid unnecessarily obscuring the present disclosure.

Use of the phrases ‘to,’ ‘capable of/to,’ and or ‘operable to,’ in one implementation, refers to some apparatus, system, component, member, and/or element designed in such a way to enable use of the apparatus, system, component, member, and/or element in a specified manner. Note as above that use of ‘to,’ ‘capable to,’ or ‘operable to,’ in one implementation, refers to the latent state of an apparatus where the apparatus is not operating but is designed in such a manner to enable use of an apparatus in a specified manner.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” on “in some embodiment” in various places throughout this specification are not necessarily all referring to the same embodiment. Furthermore, the particular features, structures, or characteristics may be combined in any suitable manner in one or more embodiment.

In the foregoing specification, a detailed description has been given with reference to specific exemplary implementations. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of implementation and other exemplarily language does not necessarily refer to the same implementation or the same example, but may refer to different and distinct implementations, as well as potentially the same implementation.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or,” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

What is claims, is:

1. A method of executing a blockchain platform, comprising:
providing, to be displayed on a client device, a virtual representation of a user, wherein the virtual representation comprises a plurality of graphical elements corresponding to a plurality of relationships of the user;
detecting, by a processing device of the blockchain platform, that a triggering event was performed;
in response to detecting that the triggering event was performed, generating blockchain token corresponding to the user;
receiving a request from the client device to redeem the blockchain token;
in response to receiving the request, generating a new graphical element, representing the blockchain token, for the virtual representation of the user; and
providing, to be displayed on the client device, an updated virtual representation including the new graphical element.

2. The method of claim 1, further comprising: in response to detecting that the triggering event was performed, generating a new graphical element, representing a relationship between the user and a third party, for the virtual representation.

3. The method of claim 1, wherein the new blockchain token further corresponds to the event and a third party, the method further comprising:
in response to detecting that the triggering event was performed, generating second blockchain token corresponding to: the user, the event, and the third party; and
sending the blockchain token to the third party.

4. The method of claim 1, wherein the virtual representation comprises a representation of a tree.

5. The method of claim 2, wherein the triggering event comprises achievement of an emotion or state of being.

6. The method of claim 1, further comprising generating a physical token corresponding to the new blockchain token.

7. The method of claim 1, further comprising detecting that the triggering event was performed by a sensor associated with the user.

8. The method of claim 7, wherein the sensor is at least one of: a resonant sensor, a photoelectric sensor, or a biometric sensor.

9. The method of claim 1, wherein a number of blockchain tokens that may be issued by the blockchain platform is unlimited.

10. A system comprising:
a memory to store a blockchain token;
a processing device coupled to the memory, the processing device to:
provide, to be displayed on a client device, a virtual representation of a user, wherein the virtual representation comprises a plurality of graphical elements corresponding to a plurality of relationships of the user;
detect, by a blockchain platform, that a triggering event was performed;
in response to detecting that the triggering event was performed, generate the blockchain token corresponding to the user;
receive a request from the client device to redeem the blockchain token;
in response to receiving the request, generate a new graphical element, representing the blockchain token, for the virtual representation of the user; and
provide, to be displayed on the client device, an updated virtual representation including the new graphical element.

11. The system of claim 10, the processing device further to: in response to detecting that the triggering event was performed, generate a new graphical element, representing a relationship between the user and a third party, for the virtual representation.

12. The method of claim 10, wherein the new blockchain token further corresponds to the event and a third party, the processing device further to:
in response to detecting that the triggering event was performed, generate a second blockchain token corresponding to: the user, the event, and the third party; and
send the blockchain token to the third party.

13. The system of claim 10, wherein the virtual representation comprises a representation of a tree.

14. The system of claim 13, wherein the triggering event comprises achievement of an emotion or state of being.

15. The system of claim 10, the processing device further to generate a physical token corresponding to the new blockchain token.

16. The system of claim 10, the processing device further to detect that the triggering event was performed by a sensor associated with the user.

17. The system of claim 16, wherein the sensor is at least one of: a resonant sensor, a photoelectric sensor, or a biometric sensor.

18. A non-transitory computer-readable storage medium including instructions that, when executed by a processing device, cause the processing device to:
provide, to be displayed on a client device, a virtual representation of a user, wherein the virtual representation comprises a plurality of graphical elements corresponding to a plurality of relationships of the user;
detect, by the processing device of a blockchain platform, that a triggering event was performed;
in response to detecting that the triggering event was performed, generate a blockchain token corresponding to the user;
receive a request from the client device to redeem the blockchain token;
in response to receiving the request, generate a new graphical element, representing the blockchain token, for the virtual representation of the user; and
provide, to be displayed on the client device, an updated virtual representation including the new graphical element.

19. The non-transitory computer-readable storage medium of claim 18, wherein the new blockchain token further corresponds to the event and a third party, processing device further to:
in response to detecting that the triggering event was performed, generate a second blockchain token corresponding to: the user, the event, and the third party; and
send the blockchain token to the third party.

20. The non-transitory computer-readable storage medium of claim 18, the processing device further to detect that the triggering event was performed by a sensor associated with the user.
